(19) United States
(12) Patent Application Publication
(10) Pub. No.: US 2016/0093191 A1
(43) Pub. Date: Mar. 31, 2016

(54) SYSTEM AND METHODS FOR EARLY WARNING OF NATURAL AND MAN-MADE DISASTERS

(71) Applicants: Ryan Anderson, Kensington, CA (US); THE REGENTS OF THE UNIVERSITY OF CALIFORNIA, Oakland, CA (US)

(72) Inventors: Joshua Bloom, Berkeley, CA (US); Ryan Anderson, Kensington, CA (US)

(21) Appl. No.: 14/866,210

(22) Filed: Sep. 25, 2015

Related U.S. Application Data
(60) Provisional application No. 62/055,059, filed on Sep. 25, 2014.

(51) Int. Cl. G08B 21/10

(52) U.S. Cl. CPC G08B 21/10

(57) ABSTRACT

An apparatus and methods for early warning of natural and man-made disasters. The apparatus is connected through the Internet to a provider of disaster warning information. A user of the apparatus determines the geographic location where the apparatus will be operated and subscribes to one or more alerting channels for that geographic location, e.g., via a cloud-based interface. Depending on the nature of the disaster and the distance from the origin of the disaster, alerts may be generated before the effects are noticed local to the device. The user can set thresholds for alert severity, and, via audible and/or visual alerts.

### CROSS-REFERENCE TO RELATED APPLICATIONS

This application claims priority to, and the benefit of, U.S. provisional patent application Ser. No. 62/055,059 filed on Sep. 25, 2014, incorporated herein by reference in its entirety.

### STATEMENT REGARDING FEDERALLY SPONSORED RESEARCH OR DEVELOPMENT

Not Applicable

### INCORPORATION-BY-REFERENCE OF COMPUTER PROGRAM APPENDIX

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND

1. Technical Field

This description pertains generally to warning systems, and more particularly to systems for early warning of natural and man-made disasters.

2. Background Discussion

Alerts about impending events that may cause bodily harm or damage can be used by people and machines as a trigger to mitigate, or completely avoid, damage/harm. For many natural and man-made disasters there is a time lag between the start of the event and the moment that harm or damage is inflicted for locations not at the origin of the event. This time lag is dependent upon the details of the event/disaster and the nature of the propagation to remote locations. The destructive forces of tsunamis travel at the speed of wave-energy propagating in oceans; toxic air conditions travel at the speed and direction of local winds around a chemical spill. Earthquake shaking travels at the speed of energy propagation in the Earth.

Given such time lags, there have been systems and devices built to provide warnings to potentially affected people/businesses. An earthquake early warning (EEW) network, for example, has been in the place for years in some of the most volatile, quake-prone places in the world. EEW networks make use of the fact that sensors close to rupture points can push shake information much faster than the speed of wave propagation of quakes. Like the observed delay between a lightening flash and the associated thunder clap increases with distance, so too can the warning time for earthquakes to locations far from the rupture/sensor sites. The Japanese EEW network provides seconds to minutes warning across the country, saving countless lives and properties.

In contrast, the EEW infrastructure in the United States is far behind. This is something that numerous researchers at the US Geological Society and other universities have been working on to rectify, as they have built the CISN ShakeAlert as a prototype EEW system. In 2013, legislation has been enacted that mandates (but does not fund) the creation of a comprehensive EEW system for California. It is estimated that another $80M will be needed to get a full-fledged system off the ground for California, Oregon and Washington states. At present, no commercially available device exists for tapping into such EEW systems with a level of robustness needed, for example, to maintain the capability of continued alerting in the case of power failure.

### BRIEF SUMMARY

The present description is an apparatus and methods for early warning of natural and man-made disasters. Preferably, the apparatus is connected through the Internet to a provider of disaster warning information. A user of the apparatus determines the geographic location where the apparatus will be operated and subscribes to one or more alerting channels for that geographic location. Preferably the subscription is established and stored via a cloud-based interface. Depending on the nature of the disaster and the distance from the origin of the disaster, alerts may be generated seconds (earthquakes), minutes (tornados), hours (tsunamis) before the effects are noticed local to the device. The user can set thresholds for alert severity, and, via audible and/or visual alerts for example, the apparatus can warn the user of the expected arrival of local shaking due to earthquakes and/or other deleterious effects due to other natural/manmade disasters and events. The technology leverages a nascent, but growing set of sensor networks that discover/predict and broadcast (including via standard internet protocols) such events.

In various embodiments, the apparatus may be mounted in a home, classroom, office, or like location just as would a smoke and/or carbon monoxide alarm. The electronics in the apparatus may be powered from a low-voltage, low-power supply (e.g., 5-volt or 3-volt input) such as provided by commonly available USB interfaces. Near-continuous operation of the apparatus may be maintained through an internal battery (with pass-through charging) that allows the apparatus to continue to function for days after external power is lost.

Preferably the apparatus maintains a constant connection to at least one network (such as a home wireless LAN), which is in turn connected to remote servers through the Internet. The apparatus may also include the capability to establish/maintain a new connection to a new network using WiFi or cellular or radio technologies to assure robust alerting. In addition to audible and/or visual alerts, the device may act as a relay (via, e.g., using Bluetooth technology) to other nearby devices which can take action upon alert. The apparatus may be configured to broadcast alerts to locally connected devices, such as radiators, which would take appropriate preventative action (e.g., shutdown of a locally connected device). A primary function of the apparatus is to alert people in its vicinity who may then take appropriate action(s) to mitigate harm to themselves or others given the impending alert.

Further aspects of the technology will be brought out in the following portions of the specification, wherein the detailed description is for the purpose of fully disclosing preferred embodiments of the technology without placing limitations thereon.

### BRIEF DESCRIPTION OF THE SEVERAL VIEWS OF THE DRAWING(S)

The technology described herein will be more fully understood by reference to the following drawings which are for illustrative purposes only:

FIG. 1 shows a high-level schematic diagram of an Early Warning (EW) system in accordance with the present description.

FIG. 2 shows a detailed schematic diagram of the components of EW apparatus of FIG. 1.

FIG. 3 and FIG. 4 provide top and bottom views, respectively, of an exemplary housing configuration for the EW apparatus of FIG. 2.

FIG. 5 shows a process flow diagram of an exemplary configuration process for connecting an EW apparatus of to the Internet.

FIG. 6 shows a process flow diagram of an exemplary operation process for selecting one or more EW publishers after an Internet connection is established.

FIG. 7 illustrates a process flow diagram of an exemplary detailed process for wireless setup and configuration of an EW apparatus.

FIG. 8 illustrates a flow diagram of an exemplary process for receiving an alert in accordance with the present description.

FIG. 9 illustrates an exemplary image of an event map where alerts are based on geographical distance from an event location.

### DETAILED DESCRIPTION

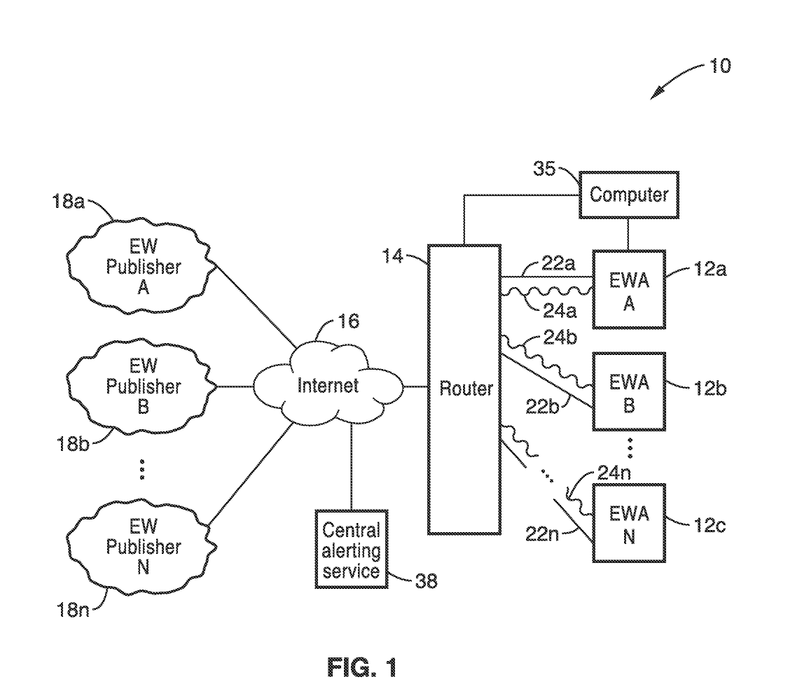

FIG. 1 through FIG. 4 illustrate a system 10 and local Early Warning Appliance (EWA) 12 in accordance with the present description that can be installed on the wall or ceiling, connected wirelessly to a local network (or networks), configured, and operated continuously until a major shaking or event is on its way. For purposes of this description, EWA 12 is detailed below as an Earthquake Early Warning Appliance or Apparatus (EEWA) 12. However, it is appreciated that EWA 12 may be capable of receiving alerts and generating warnings for any number of natural disasters and events, such as, but not limited to tsunamis, tornadoes, floods, wildfires, etc., and manmade disasters such as chemical spills, radioactive fall-out, civil unrest, and air-raids, etc. In particular, the system 10 is configured to:

(a) receive (either via push or push) alerts about earthquakes and/or other disasters/problems from remote server systems;

(b) (optionally) allow users to authenticate to alerting systems during an installation process (or reconfiguration process);

(c) (optionally) allow to device to either store (and optionally update) its geographic location so as the calculate the expected local severity (ELS) of problem and the time-lag between the expected local arrival of the impending event and/or receive ELS and time-lag data from the server(s) computed remotely for the known location of the device;

(d) (optionally) filter out alerts based on event data (such as calculated magnitude), ELS and time-lag information;

(e) (optionally) alert people near the device about the impending event using audible signals, visual events (e.g., flashes) and/or tactile events (e.g., vibration);

(f) (optionally) act as a relay, broadcasting the event to other nearby devices (e.g., via Bluetooth protocol) which in turn may be preconfigured to alert people nearby or to other devices;

(g) allow the alert data to be received via wired network (e.g., Ethernet), wireless network (e.g., WiFi), and/or cellular phone based network (e.g., CDMA);

(h) (optionally) allow network failover to occur such that if the preferred network connection should drop, the device will be capable of automatically using another network to receive data from the preferred servers;

(i) (optionally) work off of battery backup such that if wired power is lost the device can remain on and ready to receive network events.

FIG. 1 shows a high-level schematic diagram of an Early Warning (EW) system 10 in accordance with the present description. A plurality of EWA's (12a, 12b, . . . 12n) are coupled to a plurality of EW providers/publishers (18a, 18b, . . . 18n) e.g., ShakeAlert or the like, through a router 14 over the Internet 16.

In a preferred embodiment, router 14 comprises an Internet router, cellular base station router, or the like, which routes data from the EW publishers 18a through 18n to one or more EWA's 12a through 12n. Router 14 is preferably configured for use in a home, office, or similar location, and maintains Internet 16 connection via one or more services providers (ISP's—not shown). Router 14 serves to route Internet traffic to one or more of the EWA's 12a through 12n, wherein each of the EWA's 12a through 12n are configured to connect to the Internet 16 via normal connection protocols. The EWA's 12a through 12n are each configured to connect to router 14 through a network communication interface in the form of either a wired communication link or connection (22a, 22b, . . . 22n) or wireless communication link or connection (24a, 24b, . . . 24n). In the case of loss of network connectivity, the EWA's can autonomously switch to other networks, including cellular.

The EWA's 12a through 12n are configured upon first use to subscribe to one or more of the publishers 18a through 18n using the established protocols and software of the individual publisher 18a through 18n. In one embodiment, each EWA, e.g., EWA 12a, may subscribe via a “pub/sub” mechanism to an EW publisher, e.g., 18a, where the user maintains an account with EW publisher 18a. The user authenticates application software 34 (see FIG. 3) running on EWA 12a to EW publisher 18a, so that EWA 12a is sent an alert notification from EW publisher 18a in the event of an earthquake or other disaster via Internet and normal protocols (e.g., TCP/IP socket). In another embodiment, the EWA 12a may communicate with the publishers 18a through 18n through an intermediary central alerting service 38. In a preferred configuration, the user will set their geographic location as they establish a connection with EWA 12a to EW publisher 18a.

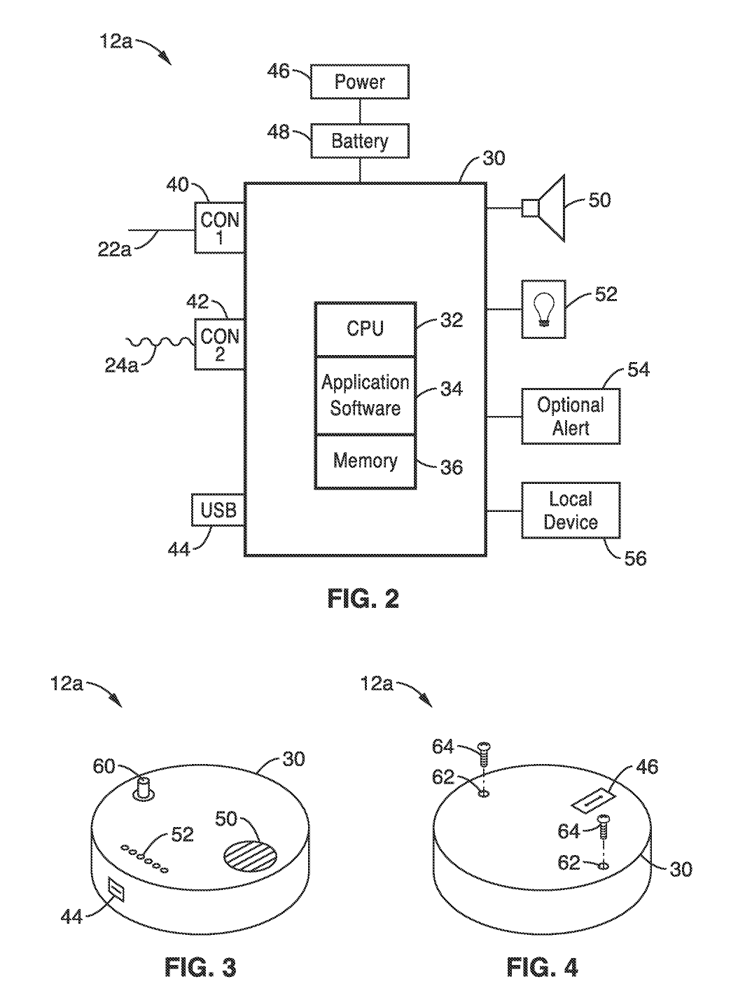

In one embodiment, programming of individual EWA's may be implemented through a personal computer/laptop 35, either through a wired port (e.g., USB port, see FIG. 2), or through router 14.

FIG. 2 shows a detailed schematic diagram of the components of EWA 12a (which may be identical to or similar to EWA's 12b through 12n) disposed within or coupled to housing 30.

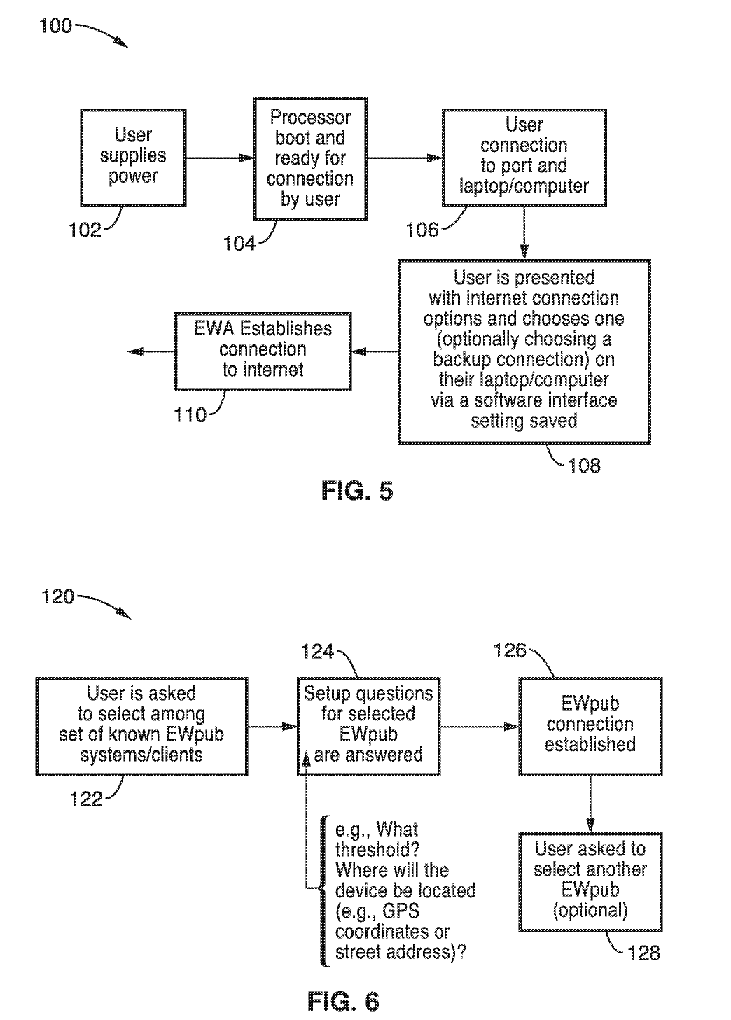

EWA 12a includes central processing hardware (CPU 32) configured for executing application software 34 for sending/receiving appropriate wireless signals over router 14 to/from one or more EW publishers 18a through 18n, and to maintain connection with EW publishers 18a-18n. Application software 34, which may comprise instructions to operate one or more of flow processes shown in FIG. 5 through FIG. 8, is preferably stored in memory 36. In one embodiment, processing hardware 32 and memory 36 may comprise a mini-computer, such as a Raspberry Pi, capable of maintaining connection with router 14 and EW publishers 18a through 18n and issuing alerts via processes shown in FIG. 5 through FIG. 8.

EWA 12a further includes wired connection hardware 40 (e.g., Ethernet port, CON 1) capable of receiving/sending appropriate wired signals to/from router 14 through wired connection 22a.

EWA 12a may also include wireless connection hardware 42 (e.g., 802g wireless card or the like, CON 2) capable of receiving/sending appropriate wired signals to/from router 14 through wireless connection 24a.

Port 44 may also be included (e.g., USB or like connection), for configuring the EWA 12a (e.g. preferences, software updates, etc.) with computer 35 or like device.

EWA 12a further includes one or more forms of emergency alert output, i.e. annunciator mechanisms, such as a speaker 50 for generating audible alerts in the form of warning sounds and/or instructions, and one or more light-emitting devices 52 (e.g., LED's LCD display, etc.) configured to issue warnings e.g., through differing colors (LED's) or messages/images (LCD). Optional alert mechanisms 54 may further be included, e.g., a remotely worn device that vibrates and is configured to warn users while sleeping, or warn certain users with hearing/vision issues. An optional connection may also be provided for coupling to an external device 56 that may be powered up/down upon a trigger.

Power is provided to the unit via power port 46 that is preferably low power (e.g., 5V USB), but may also include 120 v/240 v high power. An optional battery backup 48 may also be provided to provide power (with pass-through charging) in instances where primary power is lost. In the case of loss of power, given the low-power nature of the apparatus, the continuous operations of the apparatus can be ensured with a battery backup system that is built into the apparatus. As an alternative, wireless power options may also be considered, e.g., inductive, beamed or radiated power sources. In such embodiments, a ceiling mounted device may be powered even though it is not wired into the AC mains, and be powered off of (for example) wireless WIFI or beamed/inductive power sources. Optionally, the device may be solar optimized for indoor lighting.

FIG. 3 and FIG. 4 provide top and bottom views, respectively of an exemplary housing 30 configuration for an EWA 12a having a small form factor/mountable for use in a home/office/school. Housing 30 may comprise a polymeric, low-profile, cylindrical configuration (similar to a fire/smoke detector) that is capable of retaining speaker 50, light indicators 52, power port 46 and communication port 44. As seen in the bottom view of FIG. 4, a pair of mounting holes 62 may be provided for wall/ceiling mounting with fasteners 64.

In various embodiments, EWA 12a may also include the capability to establish/maintain a new connection to a new network using WiFi or cellular or radio technologies to assure robust alerting. In addition to audible and/or visual alerts, the EWA 12a may act as a relay (e.g., via Bluetooth or like technology) to other nearby devices (not shown), which can take action upon alert. The EWA 12a may be configured to broadcast alerts to locally connected devices, such as radiators (not shown), which would take appropriate preventative action (e.g., shutdown of a locally connected device). A primary function of the EWA 12a is to alert people in its vicinity to take appropriate action(s) given the impending alert.

FIG. 5 shows a process flow diagram of an exemplary configuration process 100 for connecting an EWA 12a to the Internet. At step 102, the user supplies power to the EWA 12a via power port 46.

Next at step 104, the processor 32 boots software 34 and readies for connection by the user. At step 106, the user connects the EWA 12a to the router 12 (e.g., via wired connection 22a or wireless connection 24a). A laptop computer 35 may also be coupled to the router 12 and used to configure EWA 12a.

At step 108, the user is presented with internet connection options and the user chooses one (and optionally chooses backup connection). This step may also be performed via computer/laptop 35 via a software interface to save settings. Finally, at step 110, the EWA 12a establishes connection with the Internet 16.

FIG. 6 shows a process flow diagram of an exemplary operation process 120 for selecting one or more EW publishers 18a-18n after the Internet connection is established. At step 122, the user is asked to select among a set of known EW publishers 18a-18n (systems, clients etc.). At step 124, a series of setup questions (e.g., alert threshold selection, location selection, etc.) for each selected EW publisher 18a through 18n. At step 126, connection with the EW publisher 18a through 18n is established. Finally at step 128, the user is optionally prompted to select an additional EW publisher 18a-18n, if so desired.

Once connected with the EW publisher 18a through 18n, the EWA 12a remains on continuously in a ready state, much like a fire alarm. All subscribed EW publisher 18a through 18n clients are left in a connected, running state. Upon alert from one of the EW publishers 18a through 18n, audible or visible signals are emitted through audible signal speaker 52 and/or visible signal indicator 50. The intensity of the warning signals may be set via configuration step 124. The user may silence an alarm via button 60.

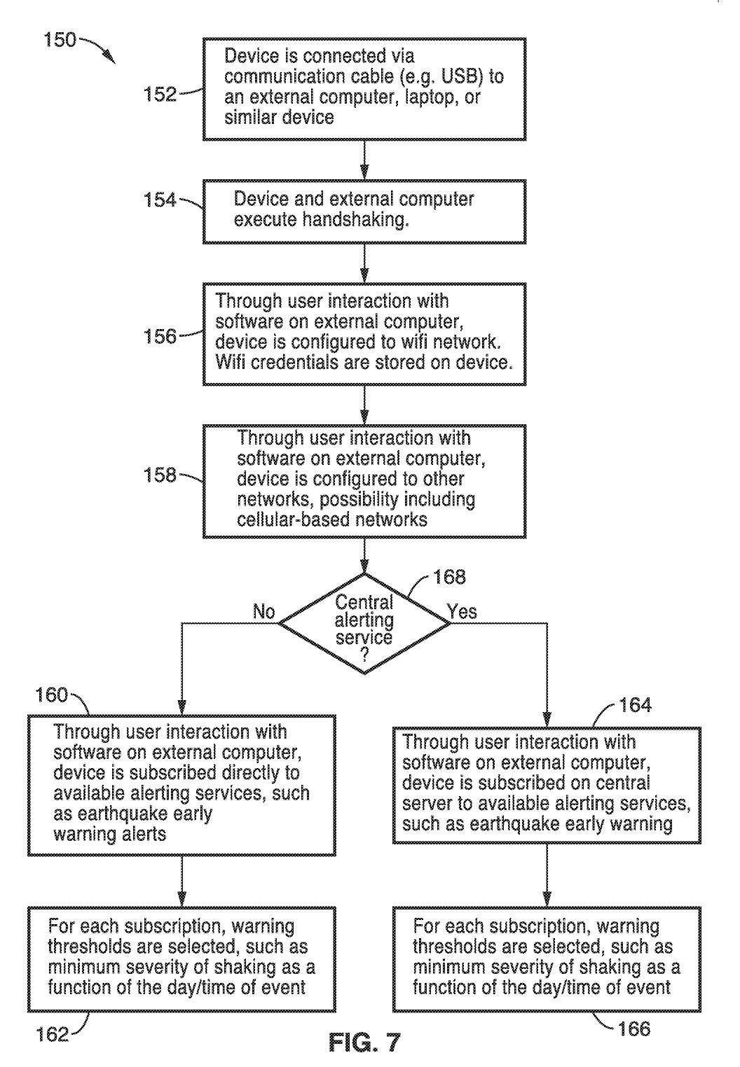

FIG. 7 illustrates a process flow diagram of an exemplary detailed process 150 for wireless setup and configuration of an EEWA 12a. First at step 152, the EWA 12a is connected via communication cable (e.g., USB port 44) to an external computer 35, laptop, or similar device. Next at step 154, the EWA 12a and external computer 35 execute handshaking. Then at step 156, through user interaction with software on external computer 35, the EWA 12a is configured to a WiFi network and WiFi credentials are stored on the EWA 12a (e.g., for connection through wireless connection 24a). Next at step 158, through user interaction with software on external computer 35, the EWA 12a is configured to other networks, possibility including cellular-based networks.

Next at step 168, the process 150 queries whether a central alerting service 38 is available.

If a central alerting service 38 is not available, through user interaction with software on external computer, the EWA 12a is subscribed directly at step 160 to available alerting services (e.g., through one or more EW publishers 18a-18n), such as earthquake early warning alerts. Then, for each subscription, warning thresholds are selected at step 162, such as minimum severity of shaking (i.e. severity of seismic event) as a function of the day/time of event.

If a central alerting service 38 is available, then through user interaction with software on the external computer, the EWA 12a is subscribed (e.g., through one or more EW publishers 18a through 18n) at step 164 on a central server to available alerting services, such as earthquake early warning alerts. Then, for each subscription, warning thresholds are selected at step 166, such as minimum severity of shaking as a function of the day/time of event.

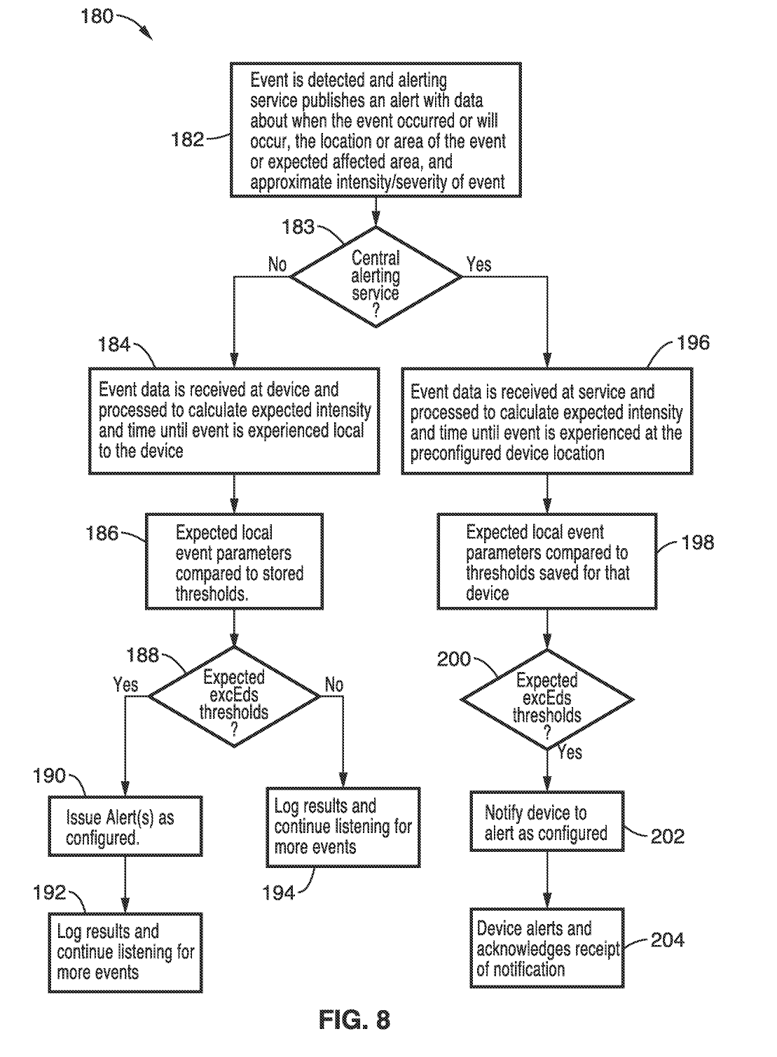

FIG. 8 illustrates a flow diagram of an exemplary process 180 for receiving an alert in accordance with the present description. First at step 182, an event is detected (e.g., through one or more EW publishers 18a through 18n) and alerting service publishes an alert with data about when the event occurred or will occur, the location or area of the event or expected affected area, and approximate intensity of the event.

Next at step 183, the process 180 queries whether a central alerting service 38 is available.

If the information is not from a central alerting service 38, event data is received at the EWA 12a and processed at step 184 to calculate expected intensity and time until event is experienced local to the EWA 12a. Expected local event parameters are then compared to stored thresholds at step 186. If the thresholds are exceeded (query at step 188), the EWA 12a issues alert(s) as configured at step 190, and results are logged and the EWA 12a continues listening for more events 192. If the thresholds are not exceeded, the EWA 12a logs results and continues listening for more events at step 194.

If the information is from a central alerting service 38, event data is received at the service and processed at step 196 to calculate expected intensity and time until the event is experienced at the preconfigured apparatus location. The expected local event parameters are then compared at step 198 to thresholds saved for that EWA 12a. If the thresholds are exceeded (step 200), the EWA 12a is notified at step 202 to alert as configured. The EWA 12a then alerts and acknowledges receipt of notification at step 204.

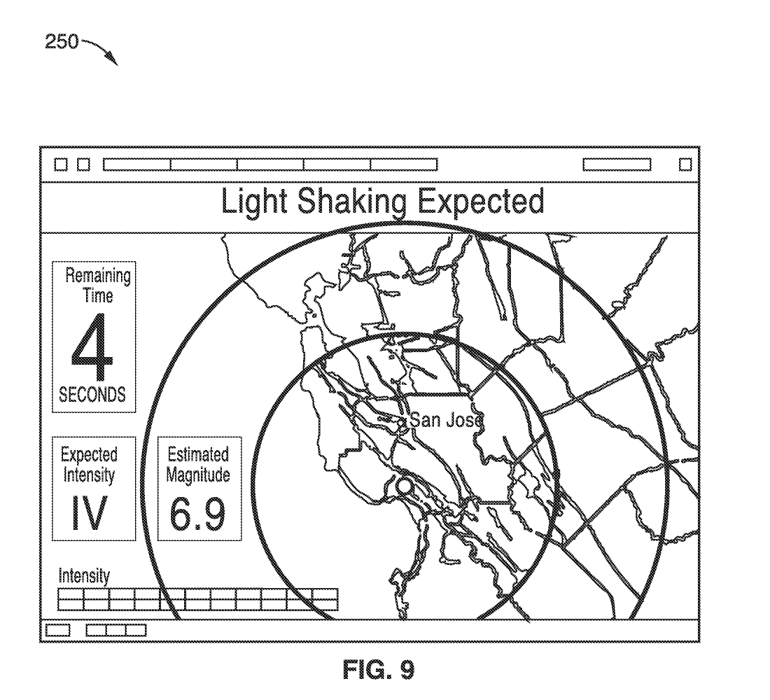

FIG. 9 illustrates an exemplary image of an event map 250 where alerts are based on geographical distance from an event location.

Beyond earthquake early warning, the systems and methods detailed through FIG. 1 through FIG. 9 may be configured to receive alerts from multiple servers of early warnings such as tsunamis, tornados, chemical spills, radioactive fall-out, civil unrest, and air-raids. The systems and methods detailed through FIG. 1 through FIG. 9 is a local, highly customizable alerting system that has several advantages over existing systems (see below).

In one embodiment configured for mass-production, the EWA 12a may be configured as a single package (housing 30), the size and form factor of a fire alarm EWA 12a would use low power (3V or 5V or power-over-Ethernet) and may have an internal (backup) battery 48. Like other wireless based home devices, the EWA 12a may be configured almost entirely through the cloud or connected laptop. Updates could be done over the air (through Internet 16) and as new warning systems come on-line they could be seamlessly added and configured to each EWA 12a. Users may be able to test their EWA 12a by manually lowering thresholds.

In another embodiment, EWA 12A may comprise a cell phone (not shown), with one or more of the processes shown in FIG. 5 through FIG. 8 implemented as application software. In such configuration, the cell phone's speaker and display may be used as the alerting annunciator mechanism. The phone could connect to Internet 16 either through WiFi, or via cellular service.

Advantages of this technology include, but are not limited to, the following:

1. The EWA 12a can be mounted almost anywhere—all that is needed is a WiFi access point in the vicinity and access to wall or USB power.

2. The EWA 12a is always powered on.

3. The EWA 12a does not require end-user to have a computer or a specific operating system.

4. The EWA 12a can include a built-in backup battery that can last for 72 hours or more after an event.

5. The EWA 12a can provide for failover to other networks (e.g., cellular, etc.) should original network (e.g., router 14) go down to maintain connectedness to alerting servers.

6. The EWA 12a can be personalizable: e.g., configurable by geo-location, alert levels and warning time, and time of day preferences. Simple configuration, in one embodiment, in the cloud.

7. The EWA 12a can be configured to receive multiple feeds of the same event (in case a server/service does not work) and multiple channels of alerts (i.e., not just earthquakes).

8. The EWA 12a is less expensive than wide-area alerting systems (e.g., neighborhood alarms). Multiple united devices could be installed in the home or school.

9. Users of the EWA 12a can be alerted when/if the EWA 12a goes off line.

Embodiments of the present technology may be described with reference to flowchart illustrations of methods and systems according to embodiments of the technology, and/or algorithms, formulae, or other computational depictions, which may also be implemented as computer program products. In this regard, each block or step of a flowchart, and combinations of blocks (and/or steps) in a flowchart, algorithm, formula, or computational depiction can be implemented by various means, such as hardware, firmware, and/or software including one or more computer program instructions embodied in computer-readable program code logic. As will be appreciated, any such computer program instructions may be loaded onto a computer, including without limitation a general purpose computer or special purpose computer, or other programmable processing apparatus to produce a machine, such that the computer program instructions which execute on the computer or other programmable processing apparatus create means for implementing the functions specified in the block(s) of the flowchart(s).

Accordingly, blocks of the flowcharts, algorithms, formulae, or computational depictions support combinations of means for performing the specified functions, combinations of steps for performing the specified functions, and computer program instructions, such as embodied in computer-readable program code logic means, for performing the specified functions. It will also be understood that each block of the flowchart illustrations, algorithms, formulae, or computational depictions and combinations thereof described herein, can be implemented by special purpose hardware-based computer systems which perform the specified functions or steps, or combinations of special purpose hardware and computer-readable program code logic means.

Furthermore, these computer program instructions, such as embodied in computer-readable program code logic, may also be stored in a computer-readable memory that can direct a computer or other programmable processing apparatus to function in a particular manner, such that the instructions stored in the computer-readable memory produce an article of manufacture including instruction means which implement the function specified in the block(s) of the flowchart(s). The computer program instructions may also be loaded onto a computer or other programmable processing apparatus to cause a series of operational steps to be performed on the computer or other programmable processing apparatus to produce a computer-implemented process such that the instructions which execute on the computer or other programmable processing apparatus provide steps for implementing the functions specified in the block(s) of the flowchart(s), algorithm(s), formula(e), or computational depiction(s).

It will further be appreciated that the terms “programming” or “program executable” as used herein refer to one or more instructions that can be executed by a processor to perform a function as described herein. The instructions can be embodied in software, in firmware, or in a combination of software and firmware. The instructions can be stored local to the device in non-transitory media, or can be stored remotely such as on a server, or all or a portion of the instructions can be stored locally and remotely. Instructions stored remotely can be downloaded (pushed) to the device by user initiation, or automatically based on one or more factors. It will further be appreciated that as used herein, that the terms processor, computer processor, central processing unit (CPU), and computer are used synonymously to denote a device capable of executing the instructions and communicating with input/output interfaces and/or peripheral devices.

From the description herein, it will be appreciated that that the present disclosure encompasses multiple embodiments which include, but are not limited to, the following:

1. An apparatus for warning a user of the occurrence of a natural or man-made event, the apparatus comprising: a network communications interface; an annunciator mechanism; a computer processor; and a non-transitory computer-readable memory storing instructions executable by the computer processor; wherein said instructions, when executed by the computer processor, perform steps comprising: (i) coupling the apparatus to one or more early warning (EW) publishing entities through the network communications interface; (ii) receiving EW data relating to a natural or man-made event from the one or more early warning (EW) publishing entities; (iii) comparing the received EW data against one or more criteria for triggering an alert; and (iv) upon the EW data meeting a threshold for the one or more criteria activating the annunciator mechanism to provide an alert signal.

2. The apparatus of any preceding embodiment, wherein the alert signal is an audible signal.

3. The apparatus of any preceding embodiment, wherein the alert signal is a visual signal.

4. The apparatus of any preceding embodiment, wherein the apparatus is coupled to the one or more early warning (EW) publishing entities via a central alerting service.

5. The apparatus of any preceding embodiment: wherein the one or more criteria for triggering an alert comprises a severity of the event; and wherein the annunciator mechanism is activated upon the expected severity of the event meeting a minimum threshold value.

6. The apparatus of any preceding embodiment: wherein the one or more criteria comprises a geographic location of the apparatus; and wherein the annunciator mechanism is activated as a function of a location of the event in relation to the geographic location and the severity of the event.

7. The apparatus of any preceding embodiment, wherein the event comprises a seismic event

8. The apparatus of any preceding embodiment, wherein said instructions, when executed by the computer processor, further perform steps comprising: (v) providing for user configuration of one or more of: selecting early warning (EW) publishing entities and establishing alert thresholds.

9. The apparatus of any preceding embodiment, wherein said instructions, when executed by the computer processor, further perform steps comprising providing said user configuration via a computer connected to the apparatus through the network communications interface or a wired port.

10. A method for warning a user of the occurrence of a natural or man-made event, the method comprising: coupling an early warning (EW) apparatus to one or more early warning (EW) publishing entities through a network communications interface; receiving at the EW apparatus EW data relating to a natural or man-made event from the one or more early warning (EW) publishing entities; comparing the received EW data against one or more criteria for triggering an alert; and activating an alert signal at the EW apparatus upon the EW data meeting a threshold for the one or more criteria.

11. The method of any preceding embodiment, wherein the alert signal is an audible signal.

12. The method of any preceding embodiment, wherein the alert signal is a visual signal.

13. The method of any preceding embodiment, wherein the EW apparatus is coupled to the one or more early warning (EW) publishing entities via a central alerting service.

14. The method of any preceding embodiment: wherein the one or more criteria for triggering an alert comprises a severity of the event; and wherein the alert signal is activated upon the severity of the event meeting a minimum threshold value.

15. The method of any preceding embodiment: wherein the one or more criteria comprises a geographic location of the apparatus; and wherein the alert signal is activated as a function of a location of the event in relation to the geographic location and the severity of the event.

16. The method of any preceding embodiment, wherein the event comprises a seismic event.

17. The method of any preceding embodiment, the method further comprising: configuring the EW apparatus with of one or more of: a selection of early warning (EW) publishing entities and alert thresholds.

18. The method of any preceding embodiment, wherein configuring the EW apparatus comprises coupling a computer to the EW apparatus through the network communications interface or a wired port.

19. An apparatus for warning a user of the occurrence of a natural or man-made event, the apparatus comprising: a network communications interface; an annunciator mechanism; a computer processor; and a non-transitory computer-readable memory storing instructions executable by the computer processor; wherein said instructions, when executed by the computer processor, perform steps comprising: (i) providing for user configuration of one or more of: selecting early warning (EW) publishing entities and establishing alert thresholds; (ii) coupling the apparatus to one or more of the publishing entities through the network communications interface; (iii) receiving EW data relating to a natural or man-made event from the one or more early warning (EW) publishing entities; (iv) comparing the received EW data against one or more criteria for triggering an alert; and (v) upon the EW data meeting a threshold for the one or more criteria, activating the annunciator mechanism to provide an alert signal; (vi) wherein the one or more criteria for triggering an alert comprises a severity of the event; and (vii) wherein the annunciator mechanism is activated upon the expected severity of the event meeting a minimum threshold value.

20. The apparatus of any preceding embodiment, wherein the alert signal comprises one or more of an audible signal or visual signal.

21. The apparatus of any preceding embodiment, wherein the apparatus is configured to operate continuously under low voltage less than 5V.

22. The apparatus of any preceding embodiment, wherein the network communications interface is configured such that in the case of loss of network connectivity, the apparatus autonomously switches from a first network to a second network.

23. The apparatus of any preceding embodiment, wherein the programming is further configured to broadcast alerts to one or more locally connected devices upon triggering the alert.

Although the description herein contains many details, these should not be construed as limiting the scope of the disclosure but as merely providing illustrations of some of the presently preferred embodiments. Therefore, it will be appreciated that the scope of the disclosure fully encompasses other embodiments which may become obvious to those skilled in the art.

In the claims, reference to an element in the singular is not intended to mean “one and only one” unless explicitly so stated, but rather “one or more.” All structural, chemical, and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. An apparatus for warning a user of the occurrence of a natural or man-made event, the apparatus comprising:
a network communications interface;
an annunciator mechanism;
a computer processor; and
a non-transitory computer-readable memory storing instructions executable by the computer processor;
wherein said instructions, when executed by the computer processor, perform steps comprising:
(i) coupling the apparatus to one or more early warning (EW) publishing entities through the network communications interface;
(ii) receiving EW data relating to a natural or man-made event from the one or more early warning (EW) publishing entities;
(iii) comparing the received EW data against one or more criteria for triggering an alert; and
(iv) upon the EW data meeting a threshold for the one or more criteria activating the annunciator mechanism to provide an alert signal.

2. An apparatus as recited in claim 1, wherein the alert signal is an audible signal.

3. An apparatus as recited in claim 1, wherein the alert signal is a visual signal.

4. An apparatus as recited in claim 1, wherein the apparatus is coupled to the one or more early warning (EW) publishing entities via a central alerting service.

5. An apparatus as recited in claim 1:
wherein the one or more criteria for triggering an alert comprises a severity of the event; and
wherein the annunciator mechanism is activated upon the expected severity of the event meeting a minimum threshold value.

6. An apparatus as recited in claim 5:
wherein the one or more criteria comprises a geographic location of the apparatus; and
wherein the annunciator mechanism is activated as a function of a location of the event in relation to the geographic location and the severity of the event.

7. An apparatus as recited in claim 5, wherein the event comprises a seismic event

8. An apparatus as recited in claim 1, wherein said instructions, when executed by the computer processor, further perform steps comprising:
(v) providing for user configuration of one or more of: selecting early warning (EW) publishing entities and establishing alert thresholds.

9. An apparatus as recited in claim 8, wherein said instructions, when executed by the computer processor, further perform steps comprising providing said user configuration via a computer connected to the apparatus through the network communications interface or a wired port.

10. A method for warning a user of the occurrence of a natural or man-made event, the method comprising:
coupling an early warning (EW) apparatus to one or more early warning (EW) publishing entities through a network communications interface;
receiving at the EW apparatus EW data relating to a natural or man-made event from the one or more early warning (EW) publishing entities;
comparing the received EW data against one or more criteria for triggering an alert; and
activating an alert signal at the EW apparatus upon the EW data meeting a threshold for the one or more criteria.

11. A method as recited in claim 10, wherein the alert signal is an audible signal.

12. A method as recited in claim 10, wherein the alert signal is a visual signal.

13. A method as recited in claim 10, wherein the EW apparatus is coupled to the one or more early warning (EW) publishing entities via a central alerting service.

14. A method as recited in claim 10:
wherein the one or more criteria for triggering an alert comprises a severity of the event; and
wherein the alert signal is activated upon the severity of the event meeting a minimum threshold value.

15. A method as recited in claim 14:
wherein the one or more criteria comprises a geographic location of the apparatus; and
wherein the alert signal is activated as a function of a location of the event in relation to the geographic location and the severity of the event.

16. A method as recited in claim 14, wherein the event comprises a seismic event.

17. A method as recited in claim 10, the method further comprising:
configuring the EW apparatus with of one or more of: a selection of early warning (EW) publishing entities and alert thresholds.

18. A method as recited in claim 17, wherein configuring the EW apparatus comprises coupling a computer to the EW apparatus through the network communications interface or a wired port.

19. An apparatus for warning a user of the occurrence of a natural or man-made event, the apparatus comprising:
a network communications interface;
an annunciator mechanism;
a computer processor; and
a non-transitory computer-readable memory storing instructions executable by the computer processor;
wherein said instructions, when executed by the computer processor, perform steps comprising:
(i) providing for user configuration of one or more of: selecting early warning (EW) publishing entities and establishing alert thresholds;
(ii) coupling the apparatus to one or more of the publishing entities through the network communications interface;
(iii) receiving EW data relating to a natural or man-made event from the one or more early warning (EW) publishing entities;
(iv) comparing the received EW data against one or more criteria for triggering an alert;
(v) upon the EW data meeting a threshold for the one or more criteria, activating the annunciator mechanism to provide an alert signal;
(vi) wherein the one or more criteria for triggering an alert comprises a severity of the event; and
(vii) wherein the annunciator mechanism is activated upon the expected severity of the event meeting a minimum threshold value.

20. An apparatus as recited in claim 19, wherein the alert signal comprises one or more of an audible signal or visual signal.

21. An apparatus as recited in claim 19, wherein the apparatus is configured to operate continuously under low voltage less than 5V.

22. An apparatus as recited in claim 19, wherein the network communications interface is configured such that in the case of loss of network connectivity, the apparatus autonomously switches from a first network to a second network.

23. An apparatus as recited in claim 19, wherein the programming is further configured to broadcast alerts to one or more locally connected devices upon triggering the alert.
